(19) United States
(12) Patent Application Publication
(10) Pub. No.: US 2026/0139818 A1
(43) Pub. Date: May 21, 2026

(54) Battery Case with Secure and Waterproof Lock, and Headlamp Comprising the Same

(71) Applicants: Raphaël Bortolotti, Annecy le Vieux (FR); Jérôme Carrier, Annecy (FR)

(72) Inventors: Raphaël Bortolotti, Annecy le Vieux (FR); Jérôme Carrier, Annecy (FR)

(21) Appl. No.: 18/955,207

(22) Filed: Nov. 21, 2024

(51) Int. Cl. F21V 21/084; F21L 4/00

(52) U.S. Cl. CPC F21V 21/084; F21L 4/005

(57) ABSTRACT

A battery housing case for a headlamp is described, including a housing body (10) having a front face, a rear face provided with a hinge (19), and two left and right side faces. The battery housing case includes a cover (20) rotatable about the hinge defining a first rotation axis, and a second rotation axis being defined at the front of the cover for rotation of a locking lever relative to the cover. The battery housing case includes a locking lever (30) having two left (31) and right (32) arms. The inner face of the left arm (31) has a first perpendicular pin (33) and the inner face of the right arm (32) has a second pin (34). The first and second pins (33, 34) are configured to be inserted into blind holes (23, 24) of the cover (20) so as to rotate the lever relative to the cover (20).

### RELATED PATENT APPLICATION

This application is related to U.S. patent application Ser. No. ______, filed on ______ (docket no. ZE24-001), which is incorporated by reference herein in its entirety, and assigned to a common assignee.

### TECHNICAL FIELD OF THE INVENTION

The present invention relates to the field of portable electric lamps and in particular, a rechargeable/non-rechargeable battery case provided with a secure and waterproof lock intended for the realization of a headlamp.

### BACKGROUND ART

Portable headlamps often have a housing for rechargeable or non-rechargeable batteries, internal or external depending on whether the weight of these batteries is to be transferred to the rear of the headlamp.

Furthermore, these headlamps are intended to be used at all times and all weathercast conditions, so that their rechargeable or not rechargeable batteries must be able to be kept in a secure and waterproof housing.

### SUMMARY OF THE INVENTION

For this purpose, a housing case is often used with a cover that can be locked onto the housing once the rechargeable/non-rechargeable batteries are in place by various mechanisms and devices.

As the weight of the batteries increases and the conditions of use become harsher, it is important to be able to improve the locking system of the housing intended to receive the housing for the rechargeable/non-rechargeable batteries in a perfectly waterproof manner.

It is an object of the present invention to provide a housing case for rechargeable or non-rechargeable batteries comprising a cover that can be closed securely and tightly by means of a double manual movement.

It is another object of the present invention to provide a headlamp housing comprising a cover that locks by a double rotation mechanism securing the locking of the cover.

It is a third object of the present invention to provide a headlamp housing comprising a perfectly sealed and waterproof housing for rechargeable/non-rechargeable batteries.

It is a fourth object of the present invention to provide a portable lamp equipped with a locking/unlocking system that is easy to handle and highly secure.

The present invention makes it possible to achieve all these objects by providing a battery housing case for rechargeable/non-rechargeable battery intended for a headlamp, comprising a case body having a front face, a rear face and two left and right side faces. The rear face has a hinge, a cover movable in rotation relative to a first axis defined by said hinge, and the cover having at its front two blind holes defining a second axis of rotation for the rotation of a locking lever relatively to the cover. The locking lever comprises two left and right branches, wherein the inner face of the left branch comprises a first perpendicular pin and the inner face of the right branch comprises a second pin. The first and second pins are configured to be inserted into said blind holes of said cover so as to complete a pivot connection of said lever relative to said cover relative to said second axis of rotation. The lever has a U-shape and further comprises, on each of the two external faces of the left and right branches, a cam having a substantially circular shape centered around said second axis of rotation. The lateral faces of said housing case comprise, at the front part, two circular grooves centered around the second axis of rotation, and configured to receive the passage of said circular cams, respectively, when the cover is in the closed position with the lever in the deployed position. The lever is pivoted to insert the circular cams into their respective circular grooves ensuring force locking.

In this way, one obtains a locking force which is more evenly distributed and this generates less deformation on the rigid elements involved for sealing the cover. This is a significant advantage over the more conventional mechanism based on the combination of a rotating axis at the bottom cooperating with a clip at the top-which would require an over sizing of the cover so as to prevent any deformation when being locked (banana effect).

In one particular embodiment the housing case comprises at the middle of the left and right side faces two pivot elements realizing a third axis of rotation around which the housing case can describe a rotational movement relative to a fixed support.

In one particular embodiment, the assembly of the hinge is carried out by means of two blind holes materializing the first axis of rotation and configured to receive two rods/pins of said cover.

Preferably, the lever is configured so as to perfectly match the shape and profile of said cover when the latter is in the finalized locking position.

### DESCRIPTION OF THE DRAWINGS

Other characteristics, purpose and advantages of the invention will appear on reading the description and the drawings below, given solely as non-limiting examples. In the attached drawings:

FIGS. 1a and 1b show two front/rear perspective views of a housing body according to the present invention.

FIGS. 2a and 2b illustrate two perspective views, front and rear, of a housing cover according to the present invention.

FIGS. 3a and 3b illustrate two perspective views, front and rear, of a locking lever according to the present invention.

FIG. 4a is a view showing a headlamp comprising a housing, its cover, and the locking lever mounted on a support.

FIG. 4B is a section of the headlamp along the CAM-CAM axis of FIG. 4a.

FIG. 5a is a section along the LEVER-LEVER axis of FIG. 4a.

FIG. 5b is a section along the AX_LEVER-AX_LEVER axis of FIG. 5a.

FIGS. 6a, 6b and 6c show three illustrative sections of the cover locking using the locking lever.

FIGS. 7a-7f illustrate perspective views of the different phases of unlocking the cover.

FIGS. 8a-8g illustrate the different phases of closing the waterproof housing by a user, highlighting the double rotation exerted when locking the housing.

### DESCRIPTION OF THE PREFERRED EMBODIMENTS

A general description will be given of a housing intended to serve for housing a rechargeable or a non-rechargeable battery serving for powering of a headlamp.

In order to reduce the weight of the load carried at the front of the user's head, the rechargeable/non-rechargeable battery housing is designed to be transferred to the back of the user's head in order to power a headlamp electronic circuit located at the front of the latter.

It should be noted, however, that this is only a particular embodiment and that the housing of the present invention should not be limited to headlamps having an external battery housing. Clearly, the innovative locking system that will be described in detail can be implemented within a single-piece headlamp comprising both the lighting system and the rechargeable/non-rechargeable battery compartment.

More generally, the housing and its locking system are designed completely independently of the LED lighting system and its associated electronics. Consequently, the housing that will be described may be associated with any lighting system, from the simplest to the most sophisticated, such as, for example, that of a lighting system incorporating a REACTIVE LIGHTING type technology marketed by the company PETZL, or any lighting system.

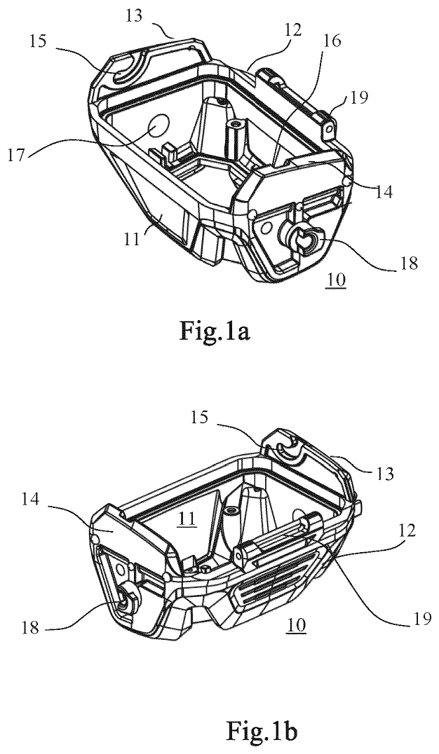

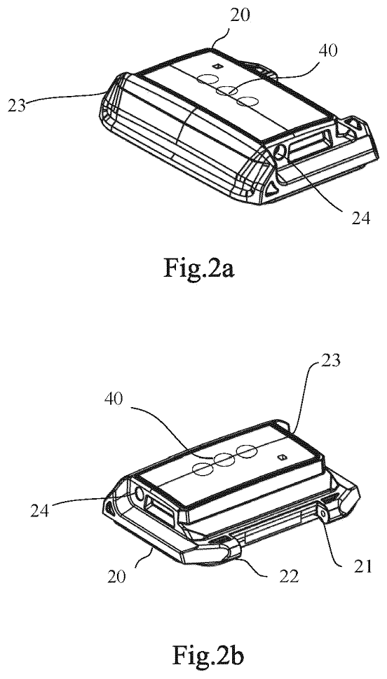

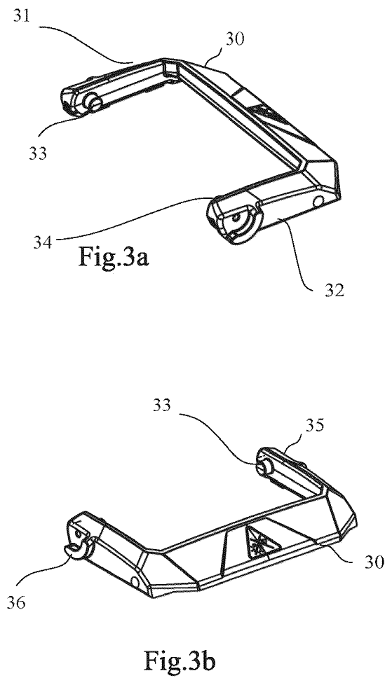

Generally speaking, the rechargeable/non-rechargeable battery housing according to the present invention comprises three constituent elements which are respectively illustrated in FIG. 1a/1b, 2a/2b and 3a/3b, namely:
a housing body 10 (FIGS. 1a and 1b);
a housing cover 20 (FIGS. 2a and 2b);
a locking lever 30 (FIGS. 3a and 3b) specifically designed to allow the locking of the cover 20.

The housing according to the invention comprises a housing body 10 of substantially parallelepipedal shape—illustrated in the two front and rear perspectives of FIGS. 1a and 1b respectively and intended to receive a housing for a non-rechargeable or rechargeable battery.

In this regard, the housing body 10 comprises a front face 11, a rear face 12 and two left 13 and right 14 side faces delimiting by means of an associated bottom a housing for a set of battery pack, being rechargeable or not. The rear face 12 comprises, at its upper rear edge, a connection system 19 with a cover 20, of the hinge type, allowing the rotation of the cover 20 relative to a first axis of rotation substantially parallel to the upper rear edge of the housing.

In a particular embodiment, the hinge is assembled at the housing by means of two blind holes materializing the first axis of rotation and configured to receive two rods/pins of the cover 20 which will be described later.

The axis of the hinge 19, as well as the left 13 and right 14 lateral faces project relative to the upper edges of the front 11 and rear 12 faces, as shown in FIGS. 1a and 1b.

Each of the left 13 and right 14 lateral faces comprises, at the front part of the housing, a groove of substantially circular shape, centered on a point defining a second axis of rotation, the functionality of which will be described later.

Finally, the housing comprises at the middle of the left and right side faces two pivot elements 17 and 18 producing a third axis of rotation 17-18, around which the housing can describe a rotational movement relative to a fixed support not illustrated in FIGS. 1a and 1b.

Cover 20 will now be described, with reference to FIGS. 2a and 2b, which is configured so as to close, in a waterproof manner, the housing of FIGS. 1a and 1b. Generally speaking, the cover 20 comprises an upper face, two left and right side faces and a rear face. In a particular embodiment, the rear side face comprises two blind holes 21 and 22 sharing the common axis of the hinge 19, and intended to receive a rotation rod (not described) for producing a pivot connection between the cover 20 and the housing 10.

Opposite the holes 21 and 22, the cover comprises respectively in its upper part, and on the left and right side faces of the cover 20, two circular holes, respectively 23 and 24, materializing the second axis of rotation mentioned above, and configured to receive two pins 33 and 34 located on the two ends of a U-shaped lever 30, so as to allow its rotation around the second axis of rotation located at the front of the cover 20. The lever 30, illustrated in FIGS. 3a and 3b, is configured so as to perfectly match the shape and profile of the cover 20 when the latter is in a horizontal plane, finalizing the locking.

The U-shaped lever 30 is illustrated more specifically in FIGS. 3a and 3b and comprises respectively two branches 31 (left) and 32 (right). The inner face of the branch 31 has at its end a first perpendicular pin 33 while the branch 32 has on its inner face a second pin 34 also at its end. The two pins 33 and 34 are intended to be inserted into the blind holes 23 and 24, respectively of cover 20 so as to achieve the pivot connection of the lever 30 relative to the cover 20 along the second axis of rotation.

The U-shaped lever 30 also has, on each of the two external faces of the branches 31 and 32, a semi-circular cam, 35 and 36 respectively, having a substantially circular shape around an axis common with the second axis of rotation.

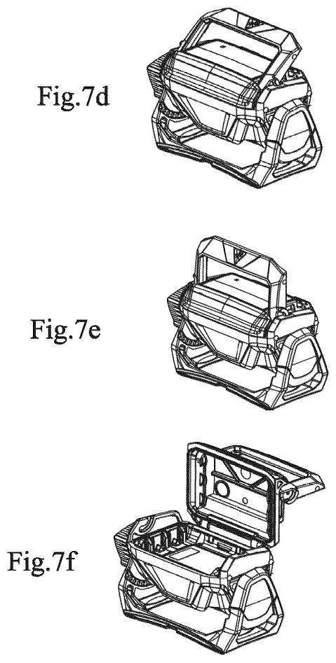

Correspondingly, the side faces 13 and 14 of the housing 10 comprise, at the front part, two circular grooves 15 and 16 configured to receive the engagement of the semi-circular cams 35 and 36, respectively, when the cover is in the closed position with the lever in a vertical plane as illustrated in FIG. 6a, and when the lever is lowered to the right to bring it into a horizontal plane (FIG. 6b and FIG. 6c), which causes the insertion of the semi-circular cams 35/36 into their respective circular grooves 15 and 16 and ensures force locking thanks to the cooperation between the semi-circular cams 35/36 and the circular grooves 15/16.

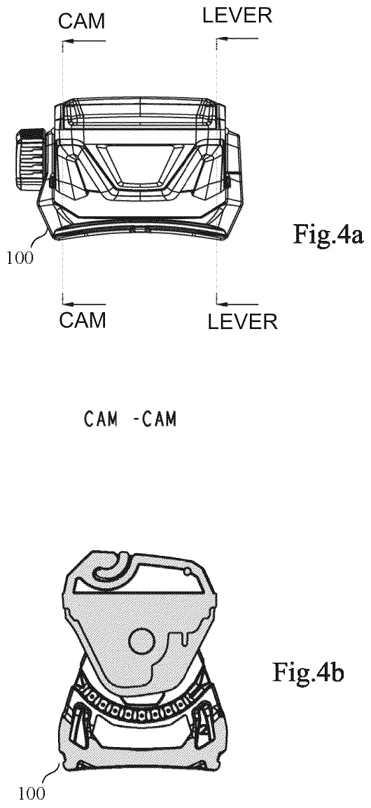

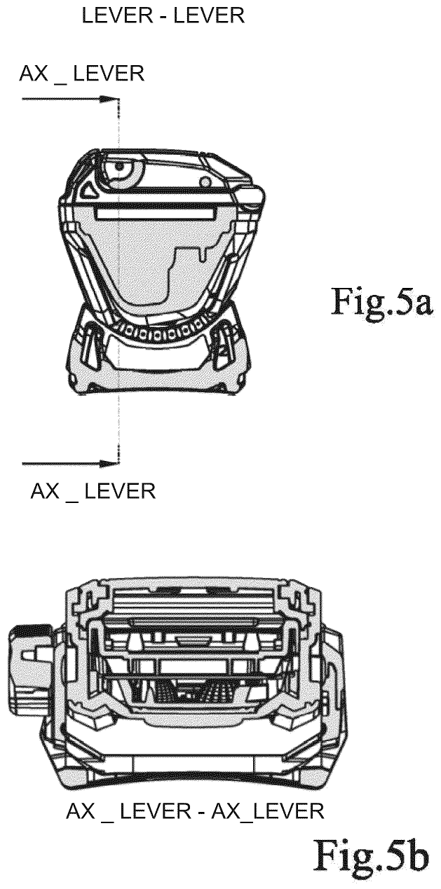

FIG. 4a is a view showing a headlamp comprising a housing, its cover and the locking lever mounted on a support 100. Two sectional views, respectively CAM-CAM and LEVER-LEVER are defined therein.

FIG. 4b is a sectional view of the headlamp along the CAM-CAM axis of FIG. 4a. It clearly shows the engagement of the cam 35 inside the circular groove 15 of the lateral face 13.

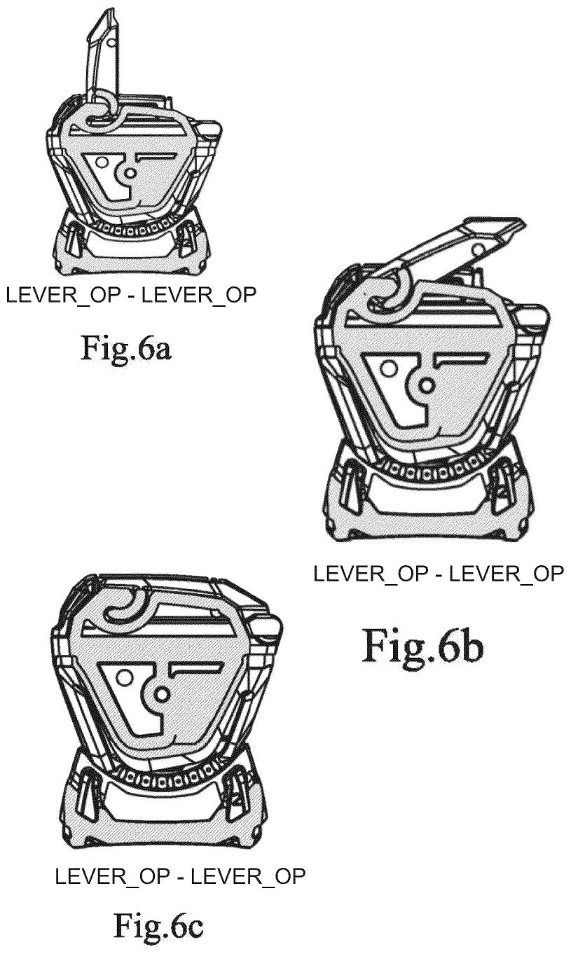

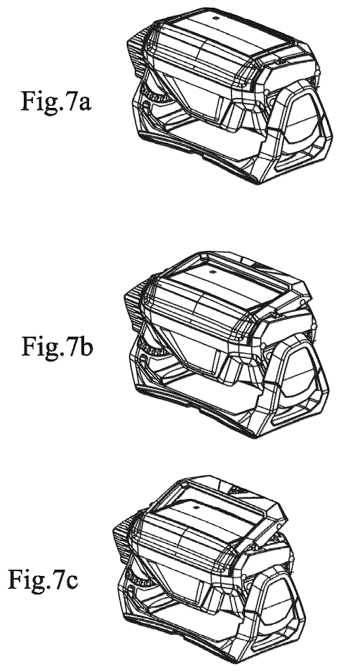

FIG. 5a is a sectional view along the LEVER-LEVER axis of FIG. 4a, also highlighting a AX_LEVER-AX_LEVER sectional view, the detail of which is illustrated in FIG. 5a.

FIGS. 6a, 6b and 6c show three illustrative sections of the cover locking by means of the locking lever, this locking lever being represented in three different positions: open, semi-open, and closed (locked). It is clearly seen that lowering the lever allows the assembly described above to be carried out between the cams 35/36 and the circular grooves 15/16, so as to ensure a tight and effective closure of the cover. It should be noted in particular that waterproofing can be achieved by means of one or more seals arranged on the cover, the details of which are not part of the present invention.

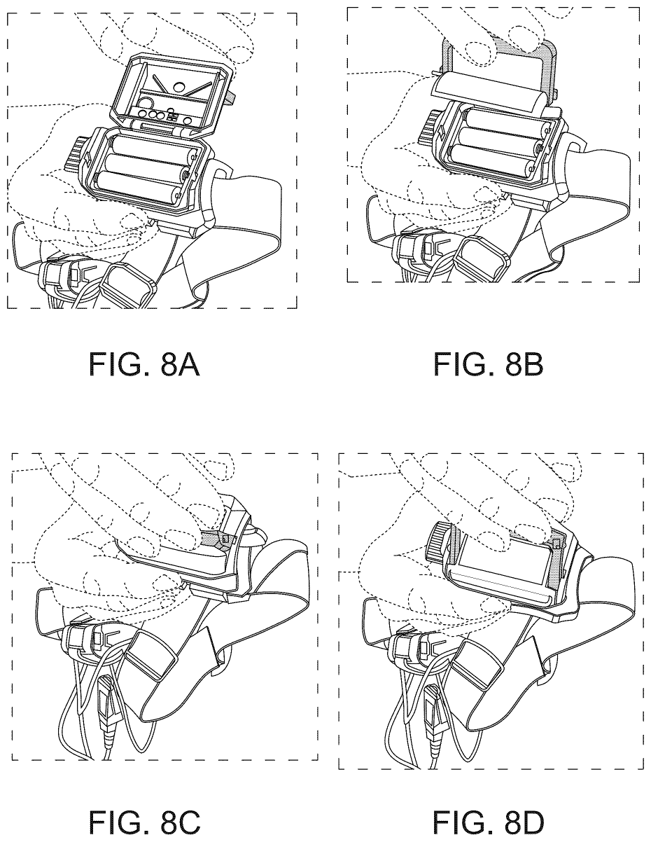

FIGS. 7a-7f illustrate perspective views of the different phases of unlocking the cover.

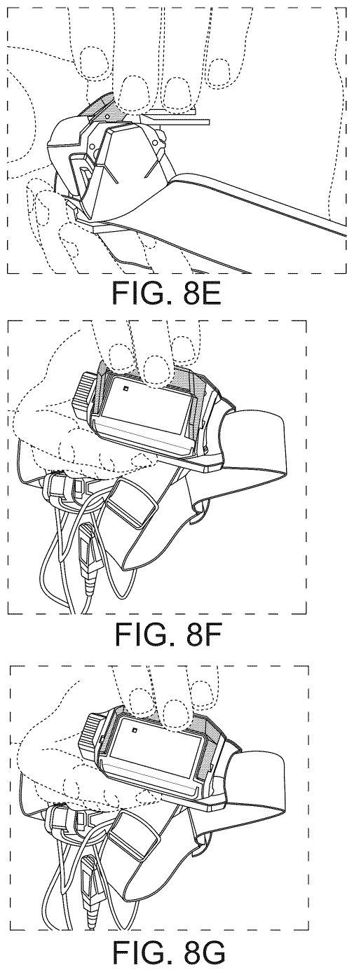

FIGS. 8a-8g illustrate the different phases of closing the waterproof housing by a user, highlighting the double rotation exerted when locking the housing.

More specifically, FIG. 8a shows the open case, in which a set of three stick batteries has been housed.

In FIG. 8b, the user begins to close the case by pivoting the cover around the hinge 19. The rotation of the cover continues until the end of its travel, as seen in FIG. 8c.

Then, as shown in FIGS. 8d and 8e, the user exerts pressure on the cover while beginning to pivot the lever around the second axis of rotation so as to cause the circular cams 35/36 to enter their corresponding circular grooves 15/16.

By lowering the lever to the end of its move, as illustrated in FIGS. 8f and 8g, the user can close the housing securely and perfectly tightly thanks to the combination of the internal seals in the cover 20 (not shown), and the pressure exerted by the cooperation of the circular cams 35/36 in their corresponding circular grooves 15/16.

What is claimed is:

1. A battery housing case for a headlamp, comprising:
a case body (10) having a front face (11), a rear face (12) and two left and right side faces (13, 14),
wherein said rear face (12) has a hinge (19) allowing rotation of a cover 20 relative to a first axis of rotation substantially parallel to the upper rear edge;
wherein each of the left and right side faces (13, 14) has, at the front portion of said case, a substantially circular groove (15, 16) centered on a point defining a second axis of rotation;
said case cover (20) has an upper face, two left and right side faces and a rear side face,
wherein said rear side face has a pivot connection allowing rotation of the cover about said first axis;
wherein said cover (20) comprises respectively on the left and right side faces a blind hole (23, 24) materializing said second axis of rotation, and configured to receive two pins (33, 34) located on the two ends of a U-shaped lever (30) so as to allow its rotation about the second axis of rotation,
said locking lever (30) comprising two left (31) and right (32) branches,
wherein the inner face of the left branch (31) comprises a first perpendicular pin (33) and the inner face of the right branch (32) comprises a second pin (34);
wherein said first and second pins (33, 34) are configured to be inserted into said blind holes (23, 24) of said cover (20) so as to complete a pivot connection of said lever (30) relative to said cover (20) about said second axis of rotation;
wherein said U-shaped lever (30) further comprises, on each of the two external faces of the left and right branches (31, 32), a cam (35, 36) having a substantially circular shape centered around said second axis of rotation;
wherein said lateral faces (13, 14) of said housing (10) comprise, at the front part, two circular grooves (15, 16) centered around the second axis of rotation, and configured to receive the passage of said circular cams (35, 36), respectively, when the cover is in the closed position with the lever in the deployed position and the lever is pivoted to insert the circular cams (35, 36) into their respective circular grooves (15, 16) ensuring force locking.

2. The battery housing case according to claim 1, in which said housing case comprises at the middle of the left and right side faces two pivot elements (17, 18) producing a third axis of rotation around which the housing can describe a rotational movement relative to a fixed support.

3. The battery housing case according to claim 2, characterized in that the assembly of said hinge (19) is carried out by means of two blind holes materializing the first axis of rotation and configured to receive two rods/pins of said cover (20).

4. The battery housing case according to claim 3 in which said lever (30) is configured so as to perfectly match the shape and profile of said cover (20) when the latter is in the finalized locking position.

5. The battery housing case according to claim 1 in which the housing case provides accommodation for an external rechargeable or non-rechargeable set of batteries allowing the remote power supply of a headlamp.

6. The battery housing case according to claim 1 in which the housing comprises a lighting system as well as a housing for rechargeable or non-rechargeable battery(s).

7. A portable lamp, such as a headlamp, comprising a battery housing case as defined in claim 1.
